(19) United States
(12) Patent Application Publication
(10) Pub. No.: US 2026/0081375 A1
(43) Pub. Date: Mar. 19, 2026

(54) ELECTRICAL PLUG CONNECTOR, CIRCUIT ARRANGEMENT AND ELECTRICAL ASSEMBLY

(71) Applicant: ROSENBERGER HOCHFREQUENZTECHNIK GMBH & CO. KG, Fridolfing (DE)

(72) Inventors: Markus Schichl, Seekirchen (AT); Folke Michelmann, Tittmoning (DE)

(21) Appl. No.: 19/108,865

(22) PCT Filed: Aug. 29, 2023
(86) PCT No.: PCT/EP2023/073722

§ 371 Date: Mar. 5, 2025

(30) Foreign Application Priority Data
Sep. 6, 2022 (DE) 10 2022 122 509.7
Oct. 12, 2022 (EP) 22201201.5

(51) Int. Cl. H01R 12/72; H01R 12/70

(52) U.S. Cl. CPC H01R 12/724; H01R 12/7011; H01R 12/721

(57) ABSTRACT

An electrical plug connector with a first end portion and a second end portion, wherein a first electrical interface is formed on the first end portion and a second electrical interface is formed on the second end portion. The electrical plug connector furthermore has an extension axis (L) extending between the first interface and the second interface. The first interface and the second interface can each be connected to a corresponding mating interface of an electrical mating plug connector along a first plugging direction (S1) oriented transverse to the extension axis (L). Between the two end portions, a third electrical interface is configured for contacting at least one electrical conductor of an electrical circuit, in particular for contacting an electrical conductor of an electrical circuit of an electrical circuit board.

The present application claims priority for German patent application No. 10 2022 122 509.7 and European patent application No. 22 201 201.5, the entire content of which is included herein by reference.

The invention relates to an electrical plug connector, in particular to a printed circuit board plug connector, with a first electrical interface, a second electrical interface, and a third electrical interface, wherein the first interface and the second interface are preferably plug-compatible with each other.

The invention moreover relates to a circuit arrangement having at least one electrical plug connector and an electrical circuit, wherein the electrical plug connector contacts at least one electrical conductor of the electrical circuit.

The invention furthermore relates to an electrical assembly having a support device and a plurality of circuit arrangements arranged on the support device.

A variety of electrical plug connectors are known in electrical engineering. Electrical plug connectors are, as is known, used to transmit electrical supply signals and/or data signals to further plug connectors or to corresponding mating plug connectors. A plug connector or mating plug connector can be a plug, a printed circuit board plug, a built-in plug, a socket, a coupling, or an adapter. The term “plug connector” or “mating plug connector” used within the scope of the invention represents all variants.

Electrical assemblies which can be populated with individual circuit arrangements in a modular fashion, for example in order to vary or expand the functionality of the electrical assembly, are sometimes used in electrical engineering. It is here necessary to distribute electrical signals (for example, supply signals) to the electrical circuits of the respective circuit arrangements. In particular when it is intended that the electrical assembly can be populated in a modular fashion, it can be advantageous to arrange in each case one electrical plug connector on sides, facing away from each other, of the individual circuit arrangements or circuits in order to relay the electrical signals from circuit arrangement to circuit arrangement. In this way, adjacent circuit arrangements can be electrically connected to one another using the plug connectors which in each case face one another, and the in each case preceding circuit arrangement can supply the following circuit arrangements with electrical data and/or supply signals. Such an electrical assembly can be used in an extremely flexible manner.

There is sometimes a requirement that it has to be possible to produce plug connectors economically in high quantities. Mounting times such as, for example, fastening the electrical plug connector to the respective circuit arrangement, for example soldering the electrical plug connector to an electrical printed circuit board, can therefore be kept as short as possible.

Taking the known prior art into consideration, the object of the present invention consists in providing an electrical plug connector which can be produced and mounted preferably inexpensively and which is suited in particular for use with an electrical assembly which can be populated with individual circuit arrangements in a modular fashion.

The object of the present invention is also to provide a circuit arrangement with an electrical plug connector which can preferably be produced and mounted inexpensively and which is suited in particular for populating an electrical assembly in a modular fashion.

The object of the invention is furthermore to provide an electrical assembly which can preferably be produced and mounted inexpensively and which is suited in particular for being populated with individual circuit arrangements in a modular fashion.

The object is achieved for the electrical plug connector with the features disclosed herein. In terms of the circuit arrangement and electrical assembly disclosed herein, the object is achieved by the features disclosed herein.

The features described below relate to advantageous embodiments and variants of the invention.

An electrical plug connector, in particular a printed circuit board plug connector, is provided. It can, however, in principle be any type of electrical plug connector, i.e. for example also a cable plug connector. The electrical plug connector is, however, preferably an electrical plug connector which can be connected to an electrical circuit (but not necessarily to an electrical circuit on an electrical printed circuit board).

According to the invention, the electrical plug connector has a first end portion and a second end portion, wherein a first electrical interface is formed at the first end portion and a second electrical interface is formed at the second end portion.

The first electrical interface and the second electrical interface are preferably in each case an interface, preferably a pluggable interface, which can be contacted electrically and/or mechanically by a further compatible plug connector or “mating plug connector”, such that plugging-together with the further plug connector or with the mating plug connector is possible.

The first interface and the second interface can preferably be connected, in particular plugged together, with a respective mating plug connector preferably independently of each other.

The first end portion and/or the second end portion of the electrical plug connector does not necessarily have to be a respective end of the plug connector. The respective electrical interface can be spaced apart from the immediate end of the electrical plug connector.

The first electrical interface can also be referred to as a first contact portion and the second electrical interface as a second contact portion. The terms are correspondingly interchangeable.

A connecting portion or connecting region can be provided between the first interface or the first contact portion and the second interface or the second contact portion.

The first electrical interface and the second electrical interface are preferably formed on sides, which face away from each other, of the electrical plug connector.

Preferably, only the first interface and no further interface is formed in the first end portion. Preferably, only the second interface and no further interface is formed in the second end portion.

The electrical plug connector preferably extends along a longitudinal axis and preferably has an essentially elongated structural form.

An axis of extent, which is preferably the longitudinal axis of the electrical plug connector, runs between the first interface and the second interface.

The axis of extent preferably runs between the two end portions and thus preferably also extends through the abovementioned connecting portion arranged between the two end portions, in particular in the manner of a central axis.

According to the invention, the first interface and the second interface can in each case be connected to a corresponding mating interface of an electrical mating plug connector at least in a first plugging direction oriented transversely to the axis of extent, in particular to an electrical mating plug connector of the same structure as the plug connector according to the invention or at least one compatible therewith.

The first interface and the second interface can therefore be connected to a respective mating plug connector. In other words, the first interface can be connected to a first mating plug connector and the second interface to a second mating plug connector.

The first plugging direction can preferably run orthogonally or at least essentially orthogonally to the axis of extent. The first plugging direction can, however, also run at any angle with respect to the axis of extent, for example be tilted by 45° or more with respect to the axis of extent, preferably be tilted by 60° or more with respect to the axis of extent, particularly preferably be tilted by 80° or more with respect to the axis of extent.

It can be provided in an advantageous development that the first interface and the second interface can, in addition to the first plugging direction, in each case be connected to the corresponding mating interface of the electrical mating plug connector in a second plugging direction oriented parallel or at least essentially parallel to the axis of extent.

It is provided according to the invention that a third electrical interface for contacting at least one electrical conductor of an electrical circuit is formed between the two end portions. The third interface is preferably formed for directly contacting the electrical conductor but possibly also only for indirectly contacting it, for example using an electrically conductive intermediate contact element.

The third interface can be connectable indirectly in particular to at least one electrical conductor of an electrical circuit of an electrical printed circuit board (PCB), i.e. in particular to a trace, a via, or a pad.

The third interface is preferably connected electrically to the first interface and the second interface.

The third interface is preferably formed in the abovementioned connecting portion.

The third interface can in principle be formed in any portion of the electrical plug connector between the two end portions, i.e. for example in a central portion of the electrical plug connector. The third electrical interface is, however, preferably closer to one of the two end portions. The third electrical interface is preferably also arranged at an end portion of the electrical plug connector, i.e. for example at the first end portion or the second end portion of the electrical plug connector.

An electrical plug connector can advantageously be provided which is capable of feeding data and/or supply signals to an electrical circuit and which furthermore can be further connected to further electrical plug connectors of a corresponding plug connector type. The further connection, i.e. the routing of the data and/or supply signals, can be effected between the said end portions of the electrical plug connector. At the same time, the electrical signal can be branched to the electrical circuit via the third interface.

It is thus particularly advantageously possible to replace the two separate plug connectors required in the prior art for further contacting with a single plug connector.

Advantages which arise therefrom include a saving in material, a reduction in structural space, and in particular also simplified mounting of the electrical plug connector on the electrical circuit because it is no longer necessary for two separate plug connectors to be (manually) connected in each case to the electrical circuit.

The electrical plug connector can be designed to electrically distribute at least one data and/or supply signal between the said electrical interfaces.

A plurality of electrical paths which are electrically insulated and/or shielded from one another, for example at least a first electrical path but preferably furthermore at least a separate second electrical path as well, can run between the interfaces. The electrical plug connector can thus be designed in particular as multipolar, for example for transmitting a direct voltage to both poles or an at least single-phase alternating voltage to the terminals. In principle, any number of current and/or data paths can be provided which, in each case insulated and/or shielded from the other current and/or data paths, are distributed by the first, second, and third interface.

According to one development of the invention, it can be provided that the first interface and the second interface are compatible with each other, preferably are plug-compatible with each other.

“Interfaces which are compatible” with each other is to be understood within the scope of the invention as meaning that the interfaces can be readily (directly) connected, in particular can be plugged together, mechanically and electrically to each other. The first interface and the second interface can therefore be designed such that they can be connected, in particular can be plugged, to each other mechanically and electrically functionally directly (as long as the two interfaces are not arranged at different ends of the same plug connector).

The fact that the first interface and the second interface are plug-compatible with each other is to be understood as meaning that the first interface can be plugged together with the second interface in order to produce an electrical and mechanical connection. This is provided, however, not with the same plug connector but with a further compatible plug connector or mating plug connector, in particular with a further plug connector according to the invention according to the embodiments above and below. A first interface of a first plug connector according to the invention can thus be connectable to a second interface of a second plug connector according to the invention, or vice versa.

According to a particularly advantageous development of the invention, it can be provided that the electrical plug connector has at least one electrical contact element which extends from the first interface to the second interface. The electrical contact element furthermore has the third interface which is formed between the first interface and the second interface.

The at least one electrical contact element can have, in the region of the said interfaces, respective contact regions which are designed for direct electrical and mechanical contacting with a corresponding mating contact element of a compatible further electrical plug connector, in particular likewise according to the invention.

The electrical contact element or its contact regions described in detail below can preferably form a main constituent of the interfaces of the electrical plug connector, possibly in conjunction with further plug connector components such as, for example, further contact elements and/or the plug connector housing mentioned below.

It can be provided in a development that the electrical plug connector has precisely two of the said electrical contact elements which are electrically insulated from each other.

A particularly advantageous use of the proposed electrical plug connector can be the supply of electrical current and voltage which can be handed over between adjacent electrical circuits. The provision of two separate electrical paths can therefore be particularly preferred such that, for example, a phase and earth connection or an anode and cathode connection can be handed over via the same electrical plug connector and at the same time can be fed to the electrical circuit.

The actual use is, however, not necessarily within the scope of the invention. In principle, the electrical plug connector can also be suited for relaying electrical data signals, i.e. for example for use with a data bus which can be expanded in a modular fashion. Mixed transmission of data and supply signals via the electrical plug connector can also be provided.

In principle, any number of contact elements can be provided which are preferably each electrically insulated from one another and optionally electromagnetically shielded from one another.

In the case of a plurality of electrical contact elements, they are preferably arranged so that they run next to one another in parallel. The electrical contact elements are for this purpose preferably spaced apart from one another. The space between the contact elements can optionally be at least partially filled by a dielectric solid body (for example, the plug connector housing mentioned below).

It can be provided that the electrical plug connector consists, in a minimalistic embodiment, of just the at least one contact element, i.e. that in particular the plug connector housing mentioned below is completely omitted.

In an advantageous development of the invention, it can be provided that the at least one electrical contact element is formed from a predominantly flat material, in particular from a sheet-metal material.

The first interface, the second interface, and/or the third interface can be designed as a flat contact. The whole contact element can possibly be designed as a flat contact.

It can in particular be provided that the electrical contact element is designed as a stamped and bent part. Other production methods are, however, possible.

According to an advantageous development of the invention, it can be provided that the first interface and the second interface are arranged, aligned with each other, along the axis of extent.

In this way, adjacent mating plug connectors can in each case be connectable to the electrical plug connector without a lateral offset such that relatively long offset-free chains of plug connectors can also be formed.

The first interface and the second interface are preferably arranged in a common contact plane, in particular such that the actual contacting of the interfaces with the corresponding mating interfaces can take place in each case in the same contact plane.

Optionally, the third interface can also be arranged so that it is aligned with the first interface and/or the second interface, possibly also in the common contact plane.

In particular, one or more bending points of the contact element can be formed between the first interface or the first end portion and the second interface or the second end portion of the electrical plug connector, for example in order to enable a defined orientation and/or positioning of the first interface relative to the second interface such that electrical plug connectors plugged together via the first and second interface are oriented in alignment, preferably in a coaxial arrangement of their longitudinal axes.

Further or alternative bending points can also be provided in the contact element, for example in order to form one of the interfaces and/or in order to form one or more of the latching elements mentioned below.

According to a development of the invention, it can be provided that the at least one contact element is formed from bronze.

The contact element is preferably formed from spring bronze.

The contact element can preferably be at least partially coated, in particular have gold-plated or nickel-plated contact regions.

The contact elements can in principle each have a multi-piece design. According to a particularly preferred development of the invention, it is however provided that each of the said contact elements is in each case designed as a single piece.

In particular, the use of one-piece contact elements has proven to be particularly advantageous for reasons of robustness, manufacturability, and mountability. The electrical resistance of a one-piece contact element can also be reduced compared with a multi-piece contact element, for which reason a correspondingly equipped electrical plug connector can be very well suited for use with high electrical currents.

In a development of the invention, it can be provided that the at least one contact element forms a first contact region of the first interface in the first end portion.

The first contact region is preferably a predominantly elongated contact region.

The direction of extent of the predominantly elongated first contact region can preferably be oriented orthogonally or at least essentially orthogonally to the longitudinal axis of the electrical plug connector or the contact element.

In a development of the invention, it can be provided that the first contact region of the at least one contact element is designed as a predominantly flat contact plate.

The predominant direction of extent of the contact plate and the plugging direction for the contact plate are preferably oriented so that they run orthogonally—or at least essentially orthogonally—to the longitudinal axis of the contact element or the electrical plug connector.

The contact surface of the contact plate is preferably completely flat or plane and—more preferably—both sides of it can furthermore be used for electrical contacting in order to enable low-resistance electrical contact with the second interface of a compatible further electrical plug connector.

In principle, the first contact region of the at least one contact element can, however, be designed as a contact element of any structure, in particular also as a contact pin. The contact pin can have a round, flat, rectangular or other polygonal cross section. Optionally but less preferably, even a spring-loaded contact pin can be provided.

In an advantageous development of the invention, it can be provided that the at least one contact element forms a second contact region of the second interface in the second end portion.

The second contact region is preferably a receptacle for the first contact region of the first interface, in particular for the predominantly elongated first contact region of the first interface, of a further electrical plug connector of a compatible construction, preferably according to the present invention.

It can thus be provided that the first interface or the first contact region of the first interface of the contact element can be plugged into the second interface or the second contact region of a contact element of a compatible further plug connector.

The receptacle for the first contact region can be designed to enable form-fitting and/or force-fitting contacting with the first contact region. A receptacle with a force fit is particularly preferred for the first contact region.

In a development of the invention, it can be provided that the receptacle of the second contact region is formed by at least one contact spring.

The use of a single contact spring can already be sufficient for receiving and force-fitting contacting of the first contact region in the second contact region when, for example, further plug connector components are provided in the second interface, such as an inner support surface of the plug connector housing mentioned below. In a particularly preferred variant, however, at least two contact springs running next to one another are provided which enable the force-fitting insertion of the first contact region between them. The use of more than two contact springs for the receptacle of the first contact region can also be provided, for example the use of three contact springs, four contact springs, five contact springs, or even more contact springs, wherein the contact springs can be arranged, for example, in the manner of a spring cage.

The use of precisely two contact springs has proved to be particularly advantageous, also for reasons of simple manufacturability, because the two contact springs can be shaped correspondingly by a simple bending process.

In an advantageous development of the invention, it can be provided that the at least one contact element forms a third contact region for the third interface.

The third contact region is preferably a contact prong or contact pin protruding from a base body of the contact element.

In an advantageous development, it can in particular be provided that the third contact region is formed as a press contact for a press-fit in a corresponding receptacle of the electrical circuit (for example, in a via of a printed circuit board) and/or as a soldering contact (for example, in order to contact a trace, via, or pad of an electrical printed circuit board using solder).

The third contact region is preferably designed at least partially as a soldering foot, soldering lug, or pad.

In principle, the third contact region can have a contact element of any type. For example, the third contact region can be designed as a contact pin (optionally even as a spring-loaded contact pin), for example also in the manner of a probe tip. One or more spring tabs can also be provided in order to form the third contact region. It can moreover be provided that the third contact region is designed in order to receive the electrical conductor (for example, a contact pin of the printed circuit board) of the electrical circuit at least partially, for example in a force-fitting and/or form-fitting fashion.

The third interface of the electrical plug connector or the third contact region of the electrical contact element is preferably designed in such a way that the connecting point between the third interface and the electrical conductor of the electrical circuit is optically visible and can thus be checked by an engineer. It can also be provided that the connecting point is accessible for intervention (for example, in the case of mounting or repair).

In a particularly advantageous development of the invention, it can be provided that the electrical plug connector has a plug connector housing.

The plug connector housing is preferably designed to enable the possibility of accessing the first, second, and third interface.

The plug connector housing can form a part of the respective interfaces, possibly together with the contact element, in order to ensure plugging compatibility. It can here optionally also be provided that the plug connector housing has mechanical contacting means in order to enable plugging-together only with a compatible mating plug connector and possibly also only in one or more defined orientations.

An electrically insulating plug connector housing is preferably provided but an electrically conductive plug connector housing can possibly also be used, in particular when the contact elements are nevertheless arranged so that they are electrically insulated from one another and possibly from the plug connector housing, for example using one or more additional dielectrics. A combination of insulating and electrically conductive housing components can in principle also be provided.

The at least one contact element is preferably fastened inside the plug connector housing.

It can in particular be provided that the plug connector housing is designed as a single piece. A multi-piece plug connector housing can, however, also be provided which has, for example, a first housing shell and a second housing shell which, in the mounted state, are latched, screwed, or rigidly connected in a different manner to each other.

The plug connector housing is preferably formed from a plastic, in particular from a thermoplastic or plastomer such as, for example, polyamide. The plug connector housing can, however, also be formed, for example, from a liquid crystal polymer (LCP).

The plug connector housing is preferably designed as an injection-molded plastic part.

In an advantageous development of the invention, it can be provided that the plug connector housing has a separate contact chamber for each contact element.

The contact chamber is preferably a predominantly slot-like contact chamber for receiving a predominantly flat contact element or a contact element formed from a sheet-metal material.

The respective contact chamber preferably extends along the longitudinal axis of the electrical plug connector, starting from a side facing the first interface, partially or completely through the plug connector housing. The direction of extent of the contact chamber can then preferably run orthogonally or at least essentially orthogonally to the first plugging direction of the first and second interface or at least essentially parallel to the axis of extent/the second plugging direction.

The contact chamber can, however, in principle extend from any side through the plug connector housing, i.e. for example also in the first plugging direction of the first and second interface or orthogonally to the axis of extent/the second plugging direction.

In a development of the invention, it can be provided that the at least one contact element is latched in the plug connector housing, preferably latched so that it can be detached as required (non-destructively).

In particular, the contact element can be latched in the respective contact chamber.

According to a development of the invention, it can be provided that, for the latching between a respective contact element and the plug connector housing, a latching tab is formed on one side and a latching catch on the other side.

In a preferred variant, the at least one contact element has one, preferably two, raised portions arranged on opposite sides for forming respective latching catches in order to latch with corresponding latching tabs in the plug connector housing. The contact element can, however, also have one or more latching tabs—the specific distribution of the latching elements is in principle not important.

The plug connector housing can optionally have one or more support surfaces for mechanical support on the electrical circuit, in particular on the electrical printed circuit board. The support surfaces are preferably designed so as to support the plug connector housing on the same upper surface of the electrical circuit on which the electrical conductor for connection to the third interface is situated.

The plug connector housing can optionally have one or more fastening elements in order to fasten the electrical plug connector mechanically to the electrical circuit, in particular to the electrical printed circuit board. The fastening elements can be, for example, latching lugs or screw elements.

It can optionally be provided that the electrical plug connector has an electromagnetic shield in order to electromagnetically shield the at least one contact element at least partially. In this case, a plurality of the electrical contact elements can be shielded individually, in groups, and/or jointly.

The electrical plug connector has, however, a design which is as minimalistic as possible and consists solely of at least one electrical contact element (preferably two contact elements) and precisely one electrically insulating plug connector housing, in particular a one-piece plug connector housing.

The invention also relates to a circuit arrangement having at least one electrical plug connector according to the embodiments above and below, and the electrical circuit with the at least one electrical conductor, wherein the third interface of the electrical plug connector electrically contacts the at least one electrical conductor. The third interface of the electrical plug connector is preferably also mechanically connected rigidly to the electrical conductor of the electrical circuit.

The electrical plug connector is advantageously suited for providing an electrical data and/or supply connection for the electrical circuit, wherein each electrical connector can, as required, provide a plurality of current and/or data paths. The corresponding data and/or supply signals can advantageously be handed over to further electrical plug connectors of the same plug connector type or at least of a compatible plug connector type or be received by such a plug connector. In this way, it is advantageously possible to connect a plurality of circuit arrangements directly to one another or in another electrical arrangement, for example in order to provide an electrical assembly which can be equipped in a modular fashion.

It can optionally be provided that the circuit arrangement has a plurality of electrical plug connectors according to the embodiments above and below which are connected to the electrical circuit, for example in order to provide a redundant or parallel data and/or supply connection and/or in order to provide further data and/or supply connections.

The invention also relates to an electrical assembly having a support device and a plurality of circuit arrangements according to the embodiments above and below arranged on the support device, wherein in each case two immediately adjacent circuit arrangements are electrically connected to each other via their respective electrical plug connector.

It can optionally be provided that the electrical assembly has at least one electrical assembly connector according to the embodiments above and below. In principle, the electrical assembly can, however, for example, also have an electrical assembly connector which has an assembly interface which is plug-compatible with the first interface and/or second interface of the electrical plug connector described above and below such that at least a first circuit arrangement (for example, an outermost circuit arrangement in a row of circuit arrangements) can be plugged with its electrical plug connector into the assembly connector of the electrical assembly.

Data and/or supply signals can be applied to the first circuit arrangement directly from the electrical assembly, for example from a control device and/or an electrical supply source of the electrical assembly. A second circuit arrangement adjacent to the first circuit arrangement can ultimately be further supplied with the data and/or supply signals from the circuit arrangement because the electrical data and/or supply signals are handed over by the proposed electrical plug connector. In this way, any desired chain of adjacent circuit arrangements can be formed.

The support device can be designed as a supporting rail, in particular a top hat rail, or be suited for fastening on a supporting rail or top hat rail.

It can be provided that the support device has respective plug-in locations for the circuit arrangements, in particular for the force-fitting and/or form-fitting receiving of the circuit arrangements.

In an advantageous development, it can be provided that the circuit arrangements can be plugged into the support device and unplugged from it individually, wherein the electrical plug connectors of the support device are designed and are arranged and oriented on the electrical circuit of the respective circuit arrangement in such a way that the plugging of the circuit arrangement into the support device simultaneously causes plugging-together of the first interface and the second interface of in each case immediately adjacent electrical plug connectors.

The invention is suited in particular for use in switchgear, in particular for use with switchgear which can be equipped in a modular fashion, wherein the circuit arrangements can be plugged into the electrical assembly as expansion modules.

The present invention is very particularly suited for providing and relaying electrical supply signals between individual circuit arrangements of the electrical assembly via the respective electrical plug connectors. The electrical plug connectors, in particular the contact elements, can, for example, be designed so as to be able to transmit an electrical voltage of between 1.0 volt and 100 volts, preferably between 5 volts and 80 volts, for example of approximately 60 volts. The electrical plug connectors, in particular the contact elements, can preferably be designed so as to be able to transmit electrical currents at the level of 0.1 ampere to 50 amperes, preferably 0.5 ampere to 20 amperes, for example of approximately 10 amperes. Even higher currents and/or voltages or also lower currents and/or voltages can, however, be provided in principle.

The invention also relates to an electrical contact element for an electrical plug connector, in particular for a printed circuit board plug connector, with a first end portion and a second end portion, wherein a first contact region is formed at the first end portion and a second contact region is formed at the second end portion, and with an axis of extent running between the first contact region and the second contact region (which preferably runs through a connecting portion formed between the two contact regions), wherein the first contact region and the second contact region can be contacted in a first plugging direction, oriented transversely to the axis of extent, of a corresponding mating contact element of an electrical mating plug connector, and wherein a third contact region for contacting at least one electrical conductor of an electrical circuit, in particular an electrical circuit of an electrical printed circuit board, is formed between the two contact regions. The invention furthermore relates to an electrical plug connector having the contact element defined above.

Features which have been described in conjunction with one of the subjects of the invention, namely provided by the electrical plug connector according to the invention, the circuit arrangement according to the invention, the electrical assembly according to the invention, and the electrical contact element according to the invention, can also be advantageously implemented for other subjects of the invention. Likewise, advantages which have been mentioned in conjunction with one of the subjects of the invention can also be understood as relating to the other subjects of the invention.

It should additionally be pointed out that terms such as “comprising”, “having”, or “with” do not exclude any other features or steps. Moreover, terms such as “a” or “the”, which indicate a singular step or feature do not exclude multiple features or steps, and vice versa.

It should be mentioned that descriptions such as “first” or “second” etc. are used predominantly for reasons of distinguishing between respective device or method features and are not necessarily intended to indicate that features are mutually dependent or are related to one another.

It should moreover be stressed that the values and parameters described in the present document include deviations or fluctuations of ±10% or less, preferably ±5% or less, more preferably ±1% or less, and very particularly preferably ±0.1% or less of the value or parameter mentioned in each case, provided that these deviations are not excluded in practice when the invention is implemented. The specification of ranges by start and end values also comprises all those values and fractions which are included by the range mentioned in each case, in particular the start and end values and a respective mean value.

The invention also relates to an electrical plug connector. Said electrical plug connector, in particular printed circuit board plug connector, has a first electrical interface and a second electrical interface, wherein the first interface and the second interface are compatible (preferably plug-compatible) with each other, and wherein a third electrical interface is formed between the two interfaces. Preferably the first interface is formed on a first end portion of the electrical plug connector and the second interface is formed on a second end portion of the electrical plug connector, wherein the third interface is formed between the two end portions. The third interface is preferably designed for contacting at least one electrical conductor of an electrical circuit, in particular an electrical circuit of an electrical printed circuit board. Said plug connector can possibly consist exclusively of an electrical contact element but can optionally also have further plug connector components such as, for example, a plug connector housing. The further features described in the present description relate to advantageous embodiments and variants of said independent electrical plug connector.

Exemplary embodiments of the invention will be described below on the basis of the drawings.

The Figures show in each case preferred exemplary embodiments in which individual features of the present invention are illustrated in combination with one another. Features of an exemplary embodiment can also be implemented separately from the other features of the same exemplary embodiment and can accordingly be readily combined by a person skilled in the art to form further expedient combinations and sub-combinations with features of other exemplary embodiments.

Elements with the same function are provided with the same reference signs in the Figures.

### IN THE DRAWINGS

FIG. 1 shows schematically a first exemplary embodiment of an electrical plug connector according to the invention with two contact elements and a one-part electrically insulating plug connector housing in a perspective illustration;

FIG. 2 shows schematically the electrical plug connector according to FIG. 1 in a further perspective illustration;

FIG. 3 shows schematically one of the contact elements of the electrical plug connector of FIGS. 1 and 2, illustrated individually in perspective;

FIG. 4 shows schematically a second exemplary embodiment of an electrical plug connector according to the invention with two contact elements and a one-part electrically insulating plug connector housing in a perspective illustration;

FIG. 5 shows schematically one of the contact elements of the electrical plug connector of FIG. 4, illustrated individually in perspective;

FIG. 6 shows schematically an electrical assembly with a plurality of circuit arrangements and electrical plug connectors according to an exemplary embodiment of the invention; and

FIG. 7 shows schematically a further variant of a contact element for use in an electrical plug connector according to the invention in a perspective illustration.

FIGS. 1 to 3 show a preferred exemplary embodiment of an electrical plug connector 1 according to the invention.

The electrical plug connector 1 has a predominantly elongated design and extends along a longitudinal axis L. A first electrical interface 3 is formed at a first end portion 2 of the electrical plug connector 1 and a second electrical interface 5 is formed at a second end portion 4. The longitudinal axis L forms an axis of extent between the two end portions 2, 4. The first interface 3 and the second interface 5 are plug-compatible with each other such that the electrical plug connector 1 can be connected to a corresponding further electrical plug connector of the same or at least a similar plug connector type. Plugging compatibility is, however, not absolutely necessary within the scope of the invention, as will be illustrated in detail below on the basis of FIG. 7.

The first interface 3 and the second interface 5 can in each case be connected at least in a first plugging direction S₁ oriented transversely to the axis of extent or longitudinal axis L (cf FIG. 1 and FIG. 6) to a corresponding mating interface of an electrical mating plug connector (not illustrated). It can optionally also be provided that the first interface 3 and the second interface 5 can be connected in each case, in addition to the first plugging direction S₁, in a second plugging direction S₂ oriented parallel to the axis of extent or longitudinal axis L, to the corresponding mating interface of the electrical mating plug connector.

A third electrical interface 6 for directly contacting at least one electrical conductor 7 of an electrical circuit 8 is provided between the two end portions 2, 4. In the exemplary embodiments, the electrical plug connector 1 is designed, by way of example, as a printed circuit board plug connector, for which reason the said third interface 6 is designed to contact the electrical conductor 7 of an electrical circuit 8 (not illustrated in detail) formed on the electrical printed circuit board 9. The electrical printed circuit board 9 is indicated in FIG. 1 in dashed lines. The combination of an electrical plug connector 1 and an electrical circuit 8 or electrical printed circuit board 9 is termed within the scope of the invention a “circuit arrangement”10.

In the exemplary embodiments, the electrical plug connector 1 has two electrical contact elements 11 which in each case extend from the first interface 3, via the third interface 6, to the second interface 5. The contact elements 11 are electrically insulated from each other or spaced apart from each other in order to form electrical paths which are independent of each other. A particularly advantageous embodiment results from the illustrated parallel arrangement of the electrical contact elements 11.

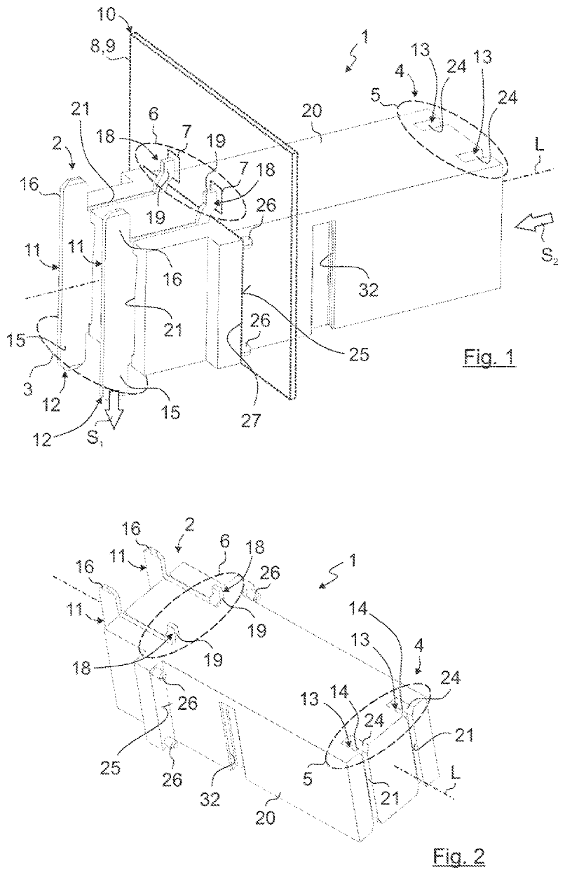

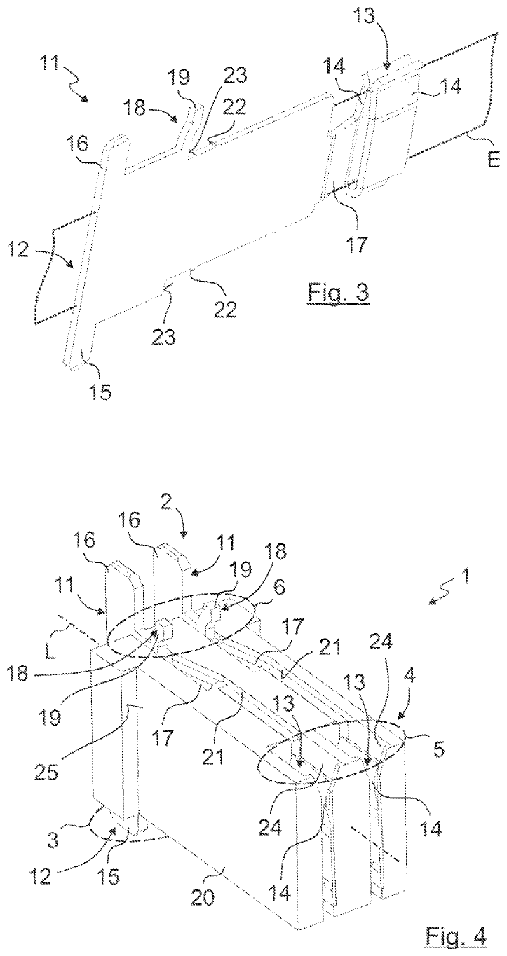

One of the contact elements 11 of the exemplary embodiment shown in FIGS. 1 and 2 of the electrical plug connector 1 is shown individually in FIG. 3.

The contact element 11 is formed from a sheet-metal material and is preferably produced as part of a stamping and bending process. The contact element 11 can preferably be formed from bronze, in particular from spring bronze, and is coated at least partially, for example in the region of the electrical interfaces 3, 5, 6. The contact element 11 can have, for example, a gold coating.

The contact elements 11 are preferably in each case designed as a single piece, as illustrated in the exemplary embodiments.

The contact elements 11 have in each case a first contact region 12 which is associated with the first end portion 2 or the first interface 3 within the electrical plug connector 1. In the exemplary embodiments, the first contact region 12 is a predominantly elongated contact region which forms a flat contact plate. In principle, a first contact region 12 of any form can, however, be provided such as, for example, also a contact pin or the like. In the exemplary embodiments, the longitudinal extent of the first contact region 12 or the contact plate is oriented orthogonally to the axis of extent or longitudinal axis L of the electrical plug connector 1, which also corresponds to the first plugging direction S₁ (cf. FIG. 1 and FIG. 6).

The second interface 5, which is plug-compatible with the contact plate or the first contact region 12, is formed by a respective second contact region 13 of the respective contact element 11, which forms a receptacle for the contact plates 12. Force-fitting receiving of the contact plates 12 in the second contact region 13 is provided, which is enabled by the configuration of the second contact region 13 in the form of two contact springs 14 running next to each other. The contact plates 12 can thus be inserted in force-fitting fashion between the contact springs 14 in their longitudinal extent. For this purpose, a portion 15, situated at the front in the plugging direction S₁, of the first contact portion 12 is provided, wherein an opposite rear portion 16 in the plugging direction S₁ is purely optional. The rear portion 16 of the first contact region 12 can optionally also be omitted. Insertion of the contact plate 12 between the contact springs 14 in the second plugging direction S₂ is preferably also possible.

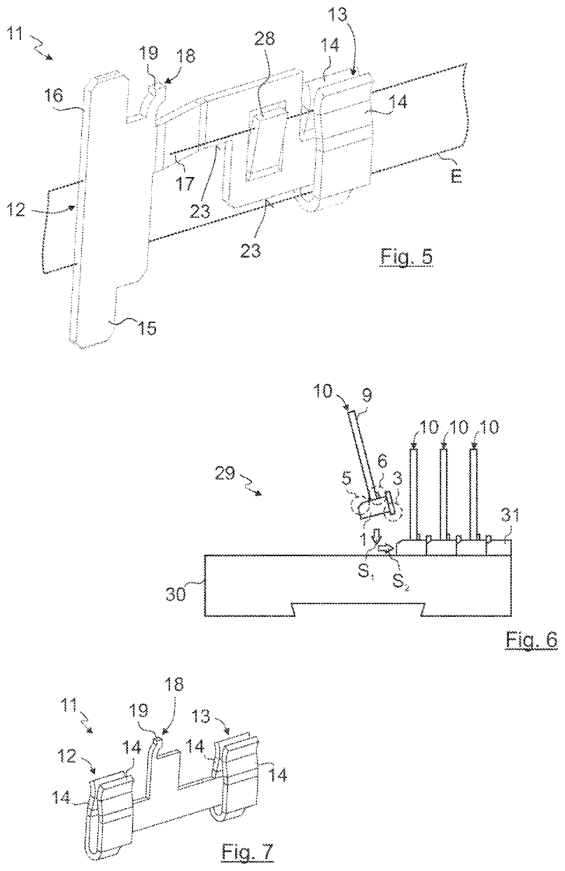

Optionally, the contact springs 14 can have a widening insertion portion, for example an insertion portion which widens in a conical or funnel shape, as illustrated for example in FIGS. 3 and 5, in order to provide insertion assistance for the first contact region 12 of a compatible plug connector.

The contact element 11 has at least one bending point 17 between the first contact region 12 and the second contact region 13 along its longitudinal axis in order to orient the first contact region 12 and the second contact region 13 preferably in alignment with each other, as can be seen particularly well on the basis of FIG. 3. In this way, the plugging-together of a plurality of plug connectors 1 according to the invention in alignment can be enabled. The first interface 3 and the second interface 5 are preferably thus arranged in a common contact plane E, as indicated in dashed lines in FIG. 3 and FIG. 5.

The contact elements 11 form a third contact region 18 for the third interface 6, in the exemplary embodiments this being a contact prong 19 protruding from the base body of the contact element 11. In the exemplary embodiments, the contact prong 19 is designed as a soldering contact for connection to an electrical conductor 7, designed as a pad, of the electrical printed circuit board 9. By virtue of the specific geometry of the contact prong 19 or because the contact prong 19 protrudes from the base body, particularly good accessibility for the engineer responsible is ensured such that the connection to the electrical printed circuit board 9 can be checked optically and, in case of doubt, can be easily accessed for repairs or alternatively for mounting or disassembly.

It should be noted at this point that the third contact region 18 does not necessarily have to be designed as a soldering contact. For example, a press contact, a contact pin, or another configuration can also be provided in order to enable preferably direct contacting with the electrical conductor 7 of the electrical circuit 8.

In the exemplary embodiments, the electrical plug connector 1 has an electrically insulating plug connector housing 20. The plug connector housing 20 is preferably manufactured from a plastic injection-molded part and is capable of receiving the contact elements 11 inside it. The plug connector housing 20 is preferably designed as a single piece, wherein, however, a multi-piece plug connector housing 20, which can for example be plugged together, can possibly also be provided.

A separate contact chamber 21, which is shaped in the manner of a slot in the exemplary embodiments, is provided in the plug connector housing 20 for each contact element 11 in order to receive the contact element 11 shaped from the sheet-metal material.

The respective contact element 11 is capable of latching in the plug connector housing 20, preferably inside the respective contact chamber 21. For this purpose, the contact elements 11 according to the preferred exemplary embodiment of FIGS. 1 to 3 have in each case raised portions which are formed on opposite sides and which form a latching catch 22 (cf FIG. 3) for an elastic latching tab inside the contact chamber 21 (not illustrated).

In the preferred exemplary embodiment of FIGS. 1 to 3, the contact chambers 21 extend from the side facing the first interface 3 completely through the plug connector housing 20 such that the contact elements 11 can be pushed into the plug connector housing 20 orthogonally to the first plugging direction S₁ of the first and second interface 3, 5 or parallel to the axis of extent L. The plug connector housing 20 is therefore completely closed on the “upper side” shown in FIGS. 1 and 2 and is particularly robust in terms of the plugging procedures.

The contact element 11 can have one or more stop faces 23 (cf for example FIG. 3) in order to provide a push-in depth limitation in the respective contact chamber 21 or in the plug connector housing 20.

The plug connector housing 20 has recesses 24 at the side of the plug connector housing 20 which is associated with the second end portion 4 in order to receive the contact plates of a further plug connector. The recesses 24 can optionally be designed as tapering conically in order to form an insertion aid.

The plug connector housing 20 optionally has the support surfaces 25 illustrated in the exemplary embodiments or other support surfaces in order to enable mechanically particularly stable connection to the printed circuit board 9.

Optionally, fastening elements 26 can furthermore be provided in order to fasten the electrical plug connector 1 to the electrical circuit 8 or to the printed circuit board 9. Illustrated by way of example in FIGS. 1 and 2 are four latching lugs 26 which are raised from the lateral support surfaces 25 and can be inserted into corresponding bores of the printed circuit board 9, preferably can be inserted or pressed in a force-fitting fashion.

It should be noted at this point that an electrical plug connector 1 according to the present invention can possibly also have only the at least one contact element 11. A plug connector housing 20 is not absolutely necessary. Moreover, in addition to the contact elements 11 and the plug connector housing 20, any desired further plug connector components can be provided such as, for example, means for electromagnetically shielding the contact elements 11. All of the exemplary embodiments are therefore given purely by way of example and are not to be understood as limiting.

It can optionally be provided that the electrical printed circuit board 9 has an opening 27 (cf FIG. 1) in order to further improve the mounting of the electrical plug connector 1 and the mechanical stability, as well as to optimize the structural space. The opening 27 can here start from one side or one edge of the printed circuit board 9 but can possibly also be designed as a window within the printed circuit board 9.

A further exemplary embodiment of a plug connector 1 according to the invention is shown in a perspective illustration in FIG. 4. One of the contact elements 11 used is shown individually in FIG. 5.

The variant of the invention shown in FIGS. 4 and 5 differs from the exemplary embodiment of FIGS. 1 to 3 essentially in the manner in which the the contact chambers 21 extend in the plug connector housing 20 or in the direction of mounting of the contact elements 11 in the plug connector housing 20.

In contrast to the exemplary embodiment of FIGS. 1 to 3, the contact elements 11 in the exemplary embodiment of FIGS. 4 and 5 can be inserted into the plug connector housing 20 in the first plugging direction S₁ of the first or second interface 3, 5. For this purpose, the plug connector housing 20 has corresponding contact chambers 21 which, in contrast to the variant above, do not extend completely through the plug connector housing 20.

In the variant shown in FIGS. 4 and 5, latching of the contact elements 11 inside the respective contact chamber 21 can be formed by a latching tab 28 of the contact elements 11 (cf FIG. 5) and corresponding latching catches in the contact chambers 21 (not illustrated).

Reference should be made to the explanations above for further technical details of the exemplary embodiment of FIGS. 4 and 5.

An electrical assembly 29 according to the invention which has a support device 30 for a plurality of circuit arrangements 10 is shown schematically in FIG. 6. The support device 30 can be designed, for example, to be mounted on a top hat rail.

The support device 30 has a module plug connector 31 which has, for connection to the first circuit arrangement 10 in the row of circuit arrangements 10, an interface which is compatible with the first interface 3 of the abovedescribed plug connector 1 such that data and/or supply signals can be applied to the first circuit arrangement 10 with its electrical plug connector 1 via the module plug connector 31.

The individual circuit arrangements 10 can preferably in each case be individually plugged into the support device 30 and unplugged from it, wherein the electrical plug connectors 1 of the support device 30 are designed and arranged and oriented on the electrical circuit 8 of the respective circuit arrangement 19 in such a way that plugging the circuit arrangement 10 into the support device 30 simultaneously causes plugging-together of the first interface 3 and the second interface 5 in each case of directly adjacent electrical plug connectors 1. A mounting movement in the first plugging direction S₁ and/or in the second plugging direction S₂ can thus be provided.

Vertical plugging-on of the individual printed circuit boards 9 or electrical circuits 8, together with the electrical plug connector 1, is preferably provided, as illustrated in FIG. 6. Optionally, the plug connectors 1, in particular the plug connector housings 20 of the plug connectors 1, can have guide and/or fastening means (cf the guide grooves 32 illustrated by way of example in FIGS. 1 and 2) in order to improve the insertion into the respective plug-in locations of the support device 30.

In each case two directly adjacent circuit arrangements 10 can be electrically connected to each other via their respective electrical plug connectors 1 in the manner proposed.

The electrical assembly 29 can ultimately be equipped in a modular and flexible fashion with circuit arrangements 10 which are ultimately supplied by handing over the electrical data and/or supply signals from the respective predecessor.

The individual circuit arrangements 10 or the electrical assembly 29 can be designed, for example, to supply, activate, and/or evaluate sensors and/or actuators of electrical switchgear.

Lastly, it is also illustrated on the basis of FIG. 7 that, within the scope of the present invention, plugging compatibility between the first interface 3 and the second interface 5 does not necessarily occur.

For this purpose, illustrated in FIG. 7 is an electrical contact element 11, the first interface and second interface 3, 5 of which have a consistent structure. The first and second interface 3, 5 have in each case two contact springs 14 running next to each other and are therefore suited in each case for an electrical and mechanical connection to a predominantly elongated mating contact element (i.e. for example a contact plate 12).

Alternatively, the first two interfaces 3, 5 can also have, for example, respective elongated contact regions 12, 13. The contact element 11 can thus be equipped, for example, with a contact plate 12 on both sides.

1. An electrical plug connector comprising a first end portion and a second end portion,
wherein a first electrical interface is formed at the first end portion and a second electrical interface is formed at the second end portion, and with an axis of extent (L) running between the first electrical interface and the second electrical interface,
wherein each of the first electrical interface and the second electrical interface is connectable to a corresponding mating interface of an electrical mating plug connector at least in a first plugging direction (S₁) oriented transversely to the axis of extent (L), and
wherein a third electrical interface for contacting at least one electrical conductor of an electrical circuit is formed between the two end portions.

2. The electrical plug connector as claimed in claim 1,
wherein the first electrical interface and the second electrical interface are arranged, aligned with each other, along (L).

3. The electrical plug connector as claimed in claim 1, wherein the first electrical interface and the second electrical interface are compatible with each other.

4. The electrical plug connector as claimed in claim 1, wherein each of the first electrical interface and the second electrical interface is connectable to the corresponding mating interface of the electrical mating plug connector in a second plugging direction (S₂) oriented parallel to the axis of extent (L).

5. The electrical plug connector as claimed in claim 1,
wherein at least one electrical contact element extends from the first electrical interface to the second electrical interface via the third electrical interface, and
wherein at least one of the first electrical interface, the second electrical interface, and the third electrical interface is configured as a flat contact.

6. The electrical plug connector as claimed in claim 5, wherein the at least one electrical contact element comprises a first electrical contact element and a second electrical contact element, and
wherein the first and second electrical contact elements are electrically insulated from each other.

7. The electrical plug connector as claimed in claim 5,
wherein each electrical contact element of the at least one electrical contact element is configured as a single piece.

8. The electrical plug connector as claimed in claim 5,
wherein the at least one electrical contact element forms a first contact region of the first electrical interface in the first end portion.

9. The electrical plug connector as claimed in claim 5,
wherein the at least one electrical contact element forms a second contact region of the second electrical interface in the second end portion.

10. The electrical plug connector as claimed in claim 5,
wherein the at least one electrical contact element forms a third contact region for the third electrical interface.

11. The electrical plug connector as claimed in claim 10,
wherein the third contact region configured as a press contact or as a soldering contact.

12. The electrical plug connector as claimed in claim 5,
further comprising a plug connector housing in which the at least one electrical contact element is fastened.

13. A circuit arrangement comprising:
an electrical circuit including at least one electrical conductor; and
at least one an electrical plug connector including
a first end portion and a second end portion,
wherein a first electrical interface is formed at the first end portion and a second electrical interface is formed at the second end portion, and with an axis of extent (L) running between the first electrical interface and the second electrical interface,
wherein each of the first electrical interface and the second electrical interface is connectable to a corresponding mating interface of an electrical mating plug connector at least in a first plugging direction (S₁) oriented transversely to the axis of extent (L), and
wherein a third electrical interface is formed between the first end portion and the second end portion;
and
wherein the third electrical interface of the at least one electrical plug connector electrically contacts the at least one electrical conductor.

14. An electrical assembly comprising:
a support device; and
a plurality of circuit arrangements positioned on the support device,
wherein each arrangement of the plurality of circuit arrangements comprises
(a) an electrical circuit including at least one electrical conductor, and
(b) at least one electrical plug connector including a first end portion and a second end portion,
wherein a first electrical interface is formed at the first end portion and a second electrical interface is formed at the second end portion, and with an axis of extent (L) running between the first electrical interface and the second electrical interface,
wherein each of the first electrical interface and the second electrical interface is connectable to a corresponding mating interface of an electrical mating plug connector at least in a first plugging direction (S₁) oriented transversely to the axis of extent (L), and
wherein a third electrical interface is formed between the first end portion and the second end portion, and
wherein the third electrical interface of the at least one electrical plug connector electrically contacts the at least one electrical conductor;
wherein two directly adjacent circuit arrangements of the plurality of circuit arrangements are electrically connected to each other via their respective electrical plug connector.

15. The electrical assembly as claimed in claim 14, wherein a circuit arrangement of the plurality of the circuit arrangements is individually pluggable into the support device and individually unpluggable from the support device,
wherein the at least one electrical plug connectors of the respective circuit arrangement is arranged on the electrical circuit of the respective circuit arrangement such that plugging of the respective circuit arrangement into the support device simultaneously causes plugging-together of the first electrical interface and the second electrical interface of directly adjacent electrical plug connectors.

16. The electrical plug connector as claimed in claim 2, wherein the first electrical interface and the second electrical interface are arranged, aligned with each other, in a common contact plane (E).

17. The electrical plug connector as claimed in claim 3, wherein the first electrical interface and the second electrical interface are plug-compatible with each other.

18. The electrical plug connector as claimed in claim 6, wherein the first and second electrical contact elements arranged so that they run next to each other in parallel.

19. The electrical plug connector as claimed in claim 8, wherein the first contact region is predominantly elongated.

20. The electrical plug connector as claimed in claim 9, wherein the second contact region is configured as a receptacle for a first contact region of the first electrical interface of a further electrical plug connector.
